(19) United States
(12) Patent Application Publication
(10) Pub. No.: US 2008/0308766 A1
(43) Pub. Date: Dec. 18, 2008

(54) STABILITY IMPROVEMENT OF LIQUID HYPOCHLORITE-CONTAINING WASHING AND CLEANING COMPOSITIONS

(76) Inventors: Carlos Malet, Sant Boi de Llobregat (ES); Carolina Perez, Cadiz (ES); Miguel Osset, Sant Pere de Vilamajor (ES)

Correspondence Address: PAUL & PAUL, 2000 MARKET STREET, Suite 2900, PHILADELPHIA, PA, 19103-3229, US

(21) Appl. No.: 12/129,232

(22) Filed: May 29, 2008

Related U.S. Application Data
(63) Continuation of application No. PCT/EP2006/011348, filed on Nov. 27, 2006.

(30) Foreign Application Priority Data
Dec. 6, 2005 (DE) 10 2005 058 339.3

(51) Int. Cl. C09K 3/00

(52) U.S. Cl. 252/186.25

(57) ABSTRACT

The improvement of shelf stability in hypochlorite-containing aqueous liquid washing and/or cleaning agents that contain colored metal pigment is achieved by the use of an alkali iodide and a sterically hindered amine.

### CROSS-REFERENCE TO RELATED APPLICATIONS

This application is a continuation under 35 U.S.C. Section 365(c) and 35 U.S.C. Section 120 of International Application No. PCT/EP2006/011348, filed Nov. 27, 2006. This application also claims priority under 35 U.S.C. Section 119 of German Patent Application No. DE 10 2005 058 339.3, filed Dec. 6, 2005. Both the International Application and the German Application are incorporated herein by reference in their entireties.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention relates to the stabilization of hypochlorite-containing liquid washing agents and/or cleaning agents for hard surfaces in households, for example, for cleaning tiles.

Sodium hypochlorite is known as a highly effective bleaching agent, and has been used for a long time, if applicable together with soaps and/or synthetic surfactants, for removing spots and all kinds of stains when laundering textiles, and also for the cleaning of hard surfaces. For household use it is normally marketed in concentrations from approximately 2 to 10 wt % in water. For such preparations, it is not unusual for them to contain hydrotropes in order to regulate their viscosity.

Liquid washing-agent preparations, or corresponding preparations of cleaning agents for hard surfaces, that contain hypochlorite as a bleach component are susceptible to a loss in activity when stored for a long period, in particular, because of the decomposition of the hypochlorite that then occurs. Also among the ingredients that are desired from application standpoints or for aesthetic reasons in washing and cleaning agents, in addition to the active substances (in this case especially the hypochlorite) that critically influence the performance of such agents, are coloring agents that are intended to give liquid preparations, in particular, a pleasant visual appearance. Dyes in particular are as a general rule easily oxidatively attacked by hypochlorite, so that the color impression of hypochlorite-containing liquid agents changes rapidly during storage.

Although there are several proposals for stabilizing alkali hypochlorite in aqueous systems, alternative approaches to a solution are nevertheless worth investigating.

(2) Description of Related Art, Including Information Disclosed Under 37 C.F.R. Sections 1.97 and 1.98.

European Patent Application EP 0 903 403, for example, suggests the use of an alkyl(alkoxy)ₙ sulfate (where n=0.5 to 20), which must contain only small proportions of undulated material and very small proportions of metal contaminants, to increase the chemical stability of liquid bleaching agents that contain a hypohalite.

### BRIEF SUMMARY OF THE INVENTION

It has now been found, surprisingly, that certain sterically hindered amines have a pronounced stabilizing effect both on hypochlorite in aqueous liquid washing and cleaning agents and on color pigments that normally are quickly decomposed in such agents by the hypochlorite. As a further advantage, it has been observed that as a result of a synergistic effect between such sterically hindered amines and alkali iodides, larger quantities of dyes than would otherwise be possible can be incorporated into hypochlorite-containing agents.

### BRIEF DESCRIPTION OF THE SEVERAL VIEWS OF THE DRAWING(S)

Not Applicable

### DETAILED DESCRIPTION OF THE INVENTION

A subject of the invention is therefore the combined use of an alkali iodide and of a sterically hindered amine that comprises the group having the general formula (I)

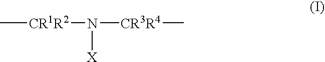

in which the radicals R¹, R², R³, and R⁴, mutually independently, denote hydrogen, a methyl group, or an ethyl group, with the stipulation that no more than two of said radicals are simultaneously hydrogen, and X denotes hydrogen, oxygen, a methyl group, an ethyl group, —OH, or —OR⁵, R⁵ being a C₁₋₄ alkyl group or a cyclohexyl group, for stabilizing hypochlorite-containing aqueous liquid compositions that contain colored metal pigment.

A second subject of the invention is an aqueous liquid bleaching agent containing alkali hypochlorite and colored metal pigment, which agent is characterized in that it additionally comprises a combination of alkali iodide and sterically hindered amine that comprises the group having the general formula (I)

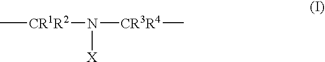

in which the radicals R¹, R², R³, and R⁴, mutually independently, denote hydrogen, a methyl group, or an ethyl group, with the stipulation that no more than two of said radicals are simultaneously hydrogen, and X denotes hydrogen, oxygen, a methyl group, an ethyl group, —OH, or —OR⁵, R⁵ being a C₁₋₄ alkyl group or a cyclohexyl group.

Among the amines preferred according to the present invention are those in which the group of the general formula (I) is part of a piperidine ring. In these, the piperidine ring preferably comprises, in addition to the substituents R¹, R², R³, R⁴, and X, a substituent in the 4-position that is —OH, —NHR⁶, or oxygen joined via a double bond, R⁶ being a C₁₋₄ alkyl group or a cyclohexyl group.

It is normally sufficient if more than 0 wt % up to approximately 0.1 wt %, in particular, approximately 0.0005 wt % to no more than approximately 0.03 wt %, of the sterically hindered amine is contained in the liquid agent to be stabilized.

In a preferred embodiment, the liquid agent stabilized in accordance with the invention contains 0.5 wt % to 5 wt % alkali hypochlorite, in particular, sodium hypochlorite.

Preparations of this kind are particularly suitable and very effective as cleaning agents for hard surfaces, for example, for use on walls, work surfaces, floors, and the like. Substantially because of their hypochlorite content, the agents are particularly suitable for removing stains such as those that occur in kitchens or bathrooms, including the grimy stains that can occur after bathtubs, shower stalls, and washbasins are used.

A bleaching agent in the form of hypochlorite is an essential constituent of the agents according to the present invention. Bleaching agents per se are entirely known components of cleaning-agent compositions, and are particularly successful for combating mildew and mold, stains that are often encountered in soap deposits or together with them. Although other alkali hypochlorites such as, for example, potassium hypochlorite may be used, it is nevertheless preferred to use sodium hypochlorite in agents stabilized according to the present invention. Commercially usual aqueous sodium hypochlorite solutions often contain considerable quantities of chloride salts. These can certainly be used for the manufacture of agents according to the present invention, so that it is not absolutely necessary to use high-purity NaOCl. In a preferred embodiment of the invention, the agents contain 0.5 wt % to 4.5 wt %, in particular, 1 wt % to 4 wt %, alkali hypochlorite.

The agents preferably contain more than 0 wt % to 0.01 wt %, in particular, up to 0.005 wt %, colored, in particular, blue and/or green, metal pigment. Preferred are complex compounds of nickel, cobalt, copper, iron, and/or manganese; copper phthalocyanine dyes are particularly preferred.

The stability of both the colored metal pigment and the alkali hypochlorite is elevated by the presence of alkali iodide. By preference, more than 0 wt % up to approximately 0.01 wt %, in particular, approximately 0.0005 wt % to approximately 0.003 wt %, alkali iodide, in particular, potassium iodide, is present.

The agents stabilized according to the present invention are normally alkaline, and for that purpose can contain approximately 0.1 wt % to 2 wt %, in particular, 0.1 wt % to 1.1 wt %, alkali hydroxide. The preferred alkali hydroxide is sodium hydroxide, and the alkali salts that are recited in conjunction with the other ingredients of the agents are also preferably the sodium salts.

The preparations can contain surfactants that are stable in the presence of the hypochlorite. Betaines are preferred, in particular, of the general formula (II)

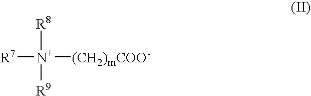

in which R⁷ is an alkyl or alkenyl group having 6 to 22 carbon atoms or an R¹⁰CO—NH—(CH₂)ₙ group, R⁸ is hydrogen or an alkyl group having 1 to 4 carbon atoms, R⁹ is hydrogen or an alkyl group having 1 to 4 carbon atoms, R¹⁰ is an alkyl or alkenyl group having 6 to 22 carbon atoms, m is a number from 1 to 6, and n is a number from 1 to 3.

Examples of particularly suitable representatives of this class of surfactants encompass C₁₂₋₁₈-alkyl dimethyl betaine, commercially obtainable as coco betaine, and C₁₀₋₁₆-alkyl dimethyl betaine, commercially obtainable as lauryl betaine. A further class of particularly preferred surfactants are the alkyl ether sulfates, which are obtainable by reacting alcohols (preferably having 6 to 22 carbon atoms) with alkylene oxides, in particular, ethylene oxide, and subsequent sulfatizing and neutralization, in particular, a C₁₂₋₁₄ fatty alcohol ether sulfate alkoxylated with 2 equivalents of ethylene oxide. The corresponding cation in the ether sulfates is preferably sodium. Surfactants, if present, are preferably contained in quantities of up to 5 wt %, in particular, from 0.01 wt % to 3 wt %, in agents stabilized according to the present invention.

The preparations can additionally contain sequestering agents, by preference alkylphosphonic acids, and among the latter especially those having at least one amine oxide substituent on the alkyl group (referred to here as amine oxide phosphonic acids), polyacrylic acids, and/or polyacrylic acids comprising phosphono groups, which acids can also be present in the form of their alkali salts. The incorporation of such complexing agents results, surprisingly, in a particularly good shine on treated hard surfaces. This is not observed when other complexing agents, for example, methylglycinediacetic acid or nitrilotriacetic acid, are used instead. Amine oxide phosphonic acids are normally manufactured by oxidation of aminoalkylphosphonic acids. They preferably belong to the group of compounds according to the general formula (III)

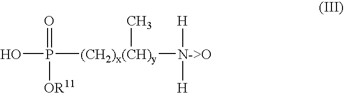

in which R¹¹ is hydrogen, a —(CH₂)ₓ(CHCH₃)_{y}—NH₂->O group, or an alkali metal, x is a number from 1 to 4, andy is 0 or 1.
Among the particularly preferred amine oxide phosphonic acids is the amine oxide based on aminotrimethylenephosphonic acid. By preference, 0.01 wt % to 2 wt % of such sequestering agents is present.

In addition to the aforementioned constituents, the preparations stabilized according to the present invention can contain small quantities of one or more bleach-stable odorants. The fragrance component contained, if applicable, is preferably of higher relative volatility than the constituents that are responsible, if applicable, for a bleach smell.

The agents stabilized according to the present invention can be manufactured easily by mixing the aforementioned ingredients in the quantities indicated.

### EXAMPLES

The preparation according to the present invention (I1) having a high pigment content, and preparations for comparison purposes without amine (C1), without potassium iodide (C2), and without either (C3), were produced by mixing the ingredients with water. The agents' compositions were as follows (wt %):

| | I1 | C1 | C2 | C3 |
|---|---|---|---|---|
| Sodium hypochlorite | 4 | 4 | 4 | 4 |
| C_{12/14} fatty alcohol 2 EO | 1.2 | 1.2 | 1.2 | 1.2 |
| sulfate, sodium salt | | | | |
| Amine^{a)} | 0.01 | — | 0.01 | — |
| Potassium iodide | 0.001 | 0.001 | — | — |
| Copper phthalocyanine | 0.005 | 0.005 | 0.005 | 0.005 |
| Sodium hydroxide | 1 | 1 | 1 | 1 |
| Water | to make | to make | to make | to make |
| | 100 | 100 | 100 | 100 |

^{a)}2,2,6,6-tetramethyl-4-hydroxypiperidine-N oxide

All the agents were placed into plastic bottles and stored for several weeks. After storage, the hypochlorite content was distinctly higher in the preparations according to the present invention than in the preparations tested for comparison. In addition, the pressure in the bottle of agent C3 had risen (presumably due to the formation of oxygen) to approximately 100 Kp after only 4 days at 60° C., whereas the pressure in the case of the agent according to the present invention was still below 20 Kp even after an extended period.

1. A process for stabilizing a hypochlorite-containing aqueous liquid composition that contains colored metal pigment comprising the step of mixing with the compositions a combination of an alkali iodide and a sterically hindered amine that comprises the group having the general formula (I) 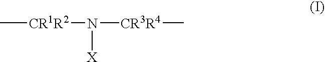
in which the radicals R¹, R², R³, and R⁴, mutually independently, denote hydrogen, a methyl group, or an ethyl group, with the stipulation that no more than two of said radicals are simultaneously hydrogen, and X denotes hydrogen, oxygen, a methyl group, an ethyl group, —OH, or —OR⁵, R⁵ being a C₁₋₄ alkyl group or a cyclohexyl group.

2. The process according to claim 1, wherein in the sterically hindered amine, the group of the general formula (I) is part of a piperidine ring.

3. The process according to claim 2, wherein in the sterically hindered amine, the piperidine ring comprises, in addition to the substituents R¹, R², R³, R⁴, and X, a substituent in position 4 that is —OH, —NHR⁶, or oxygen joined via a double bond, R⁶ being a C₁₋₄ alkyl group or a cyclohexyl group.

4. The process according to claim 1, wherein the composition contains more than 0 wt % to 0.01 wt % alkali iodide.

5. The process according to claim 1, wherein the composition contains more than 0 wt % to 0.1 wt % of the sterically hindered amine.

6. The process according to claim 1, wherein the composition contains more than 0 wt % to 0.01 wt % colored metal pigment.

7. The process according to claim 6, wherein the metal pigment is a copper phthalocyanine dye.

8. The process according to claim 1, wherein the composition contains 0.5 wt % to 5 wt % alkali hypochlorite.

9. The process according to claim 1, wherein the composition contains up to 5 wt % bleach-stable surfactant.

10. The process according to claim 1, wherein the composition contains 0.01 wt % to 2 wt % of at least one acid or salt selected from the group consisting of alkylphosphonic acid and/or alkylphosphonate, amine oxide phosphonic acid, polyacrylic acid, polyacrylic acid containing phosphono groups, and/or an alkali salt of one, two, or all three of said acids.

11. An aqueous liquid bleaching agent containing alkali hypochlorite, colored metal pigment and a combination of alkali iodide and sterically hindered amine that comprises the group having the general formula (I) 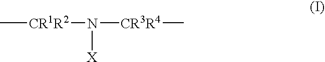
in which the radicals R¹, R², R³, and R⁴, mutually independently, denote hydrogen, a methyl group, or an ethyl group, with the stipulation that no more than two of said radicals are simultaneously hydrogen, and X denotes hydrogen, oxygen, a methyl group, an ethyl group, —OH, or —OR⁵, R⁵ being a C₁₋₄ alkyl group or a cyclohexyl group.

12. The agent according to claim 11, wherein in the sterically hindered amine, the group of the general formula (I) is part of a piperidine ring.

13. The agent according to claim 12, wherein in the sterically hindered amine, the piperidine ring comprises, in addition to the substituents R¹, R², R³, R⁴, and X, a substituent in position 4 that is —OH, —NHR⁶, or oxygen joined via a double bond, R⁶ being a C₁₋₄ alkyl group or a cyclohexyl group.

14. The agent according to claim 11, wherein the agent contains more than 0 wt % to 0.01 wt % alkali iodide.

15. The agent according to claim 11, wherein the agent contains more than 0 wt % to 0.1 wt % of the sterically hindered amine.

16. The agent according to claim 11, wherein the agent contains more than 0 wt % to 0.01 wt % colored metal pigment.

17. The agent according to claim 16, wherein the metal pigment is a copper phthalocyanine dye.

18. The agent according to claim 11, wherein the agent contains 0.5 wt % to 5 wt % alkali hypochlorite.

19. The agent according to claim 11, wherein the agent contains up to 5 wt % bleach-stable surfactant.

20. An aqueous liquid bleaching agent containing sodium hypochlorite, copper phthalacyanine, and a combination of potassium iodide and 2,2,6,6-tetramethyl-4 hydroxypiperidine-N-oxide.
